(19) United States
(12) Patent Application Publication
(10) Pub. No.: US 2023/0112306 A1
(43) Pub. Date: Apr. 13, 2023

(54) METHODS OF CONTROLLING OR PREVENTING INFESTATION OF SOYBEAN PLANTS BY THE PHYTOPATHOGENIC MICROORGANISM CORYNESPORA CASSIICOLA

(71) Applicant: SYNGENTA CROP PROTECTION AG, Basel (CH)

(72) Inventors: Laura QUARANTA, Basel (CH); David BEATTIE, Basel (CH)

(73) Assignee: SYNGENTA CROP PROTECTION AG, Basel (CH)

(21) Appl. No.: 17/911,381

(22) PCT Filed: Mar. 13, 2021
(86) PCT No.: PCT/EP2021/056434

§ 371 Date: Sep. 13, 2022

(30) Foreign Application Priority Data
Mar. 13, 2020 (EP) 20163141.3

(51) Int. Cl. A01N 43/90; A01N 43/42

(52) U.S. Cl. CPC A01N 43/90; A01N 43/42

(57) ABSTRACT

The present invention relates to methods for controlling or preventing infestation of a plant by the phytopathogenic microorganism Corynespora cassiicola, comprising applying to the phytopathogen, to the locus of the phytopathogen, or to a plant susceptible to attack by the phytopathogen, or to a propagation material thereof, a fungicidally effective amount of a compound, N-oxide or agriculturally acceptable salts thereof as defined in claim 1.

The present invention relates to methods for controlling or preventing infestation of a plant by the phytopathogenic microorganism Corynespora cassiicola.

Corynespora cassiicola infects over 530 species of plants in 53 families (Dixon, L. J., et al., 2009, Phytopathology 99(9) 1015-27). It is most common in the tropics and subtropics. It has also been isolated from nematodes and from human skin. Corynespora cassiicola is known as a pathogen of many agricultural crop plants, for example beans, cowpea, cucumber, papaya, soybean, sweet potato, and tomato. The disease caused by Corynespora cassiicola is called target leaf spot or target spot on several plants, for example tomato.

The development of resistance of the phytopathogen(s) Corynespora cassiicola to many of the current commercial solutions restricts their utility and, whilst the development of new classes of agrochemical fungicides is on-going, many of these new classes of chemistry have limitations in their fungicidal spectrum and control only certain, specific phytopathogens. That is to say that, when a new class of chemistry is shown to control certain, specific phytopathogens on certain, specific crops, it cannot be expected that the same class of chemistry will prove useful in the control of the phytopathogen Corynespora cassiicola, for example on soybean.

There exists therefore a need for the development of new methods for controlling or preventing infestation by the phytopathogen Corynespora cassiicola.

Description of the embodiments: Pyridinyl compounds according to formula (I), intermediates and processes for their preparation have been disclosed in WO2017/016915. It has now been surprisingly found that particular pyridinyl compounds disclosed in WO2017/016915 are highly effective at controlling or preventing the infestation of plants by the phytopathogenic microorganism Corynespora cassiicola. These highly effective compounds thus represent an important new solution for farmers to control or prevent infestation of plants by the phytopathogenic microorganism Corynespora cassiicola.

Hence, as embodiment 1, there is provided a method of controlling or preventing infestation of plants by the phytopathogenic microorganism Corynespora cassiicola comprising applying to the phytopathogen, to the locus of the phytopathogen, or to a plant susceptible to attack by the phytopathogen, or to a propagation material thereof, a fungicidally effective amount of a compound according to formula I:

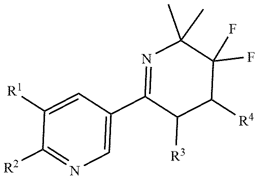

wherein R¹ and R² are each independently selected from a C₁-C₃ alkyl or C₁-C₃ halogenalkyl, or form together an unsubstituted or substituted aryl ring; and R³ and R⁴ form together an unsubstituted or substituted aryl or thiophen ring, and N-oxides and the agriculturally acceptable salts thereof.

Methods for the preparation of the compounds of embodiment 1 and according to formula I are described in WO2017/016915. More preferred methods according to embodiment 1 are given in the embodiments below.

In a preferred embodiment of the compound of formula (I), R¹ and R² are each independently methyl, or R¹ represents methyl and R² represents —CHF₂.

Particularly preferred compounds (I) are selected from

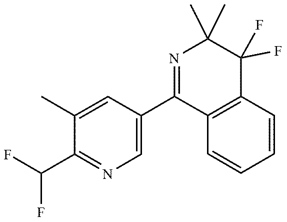 [SMILES: Cc1cc(C2=NC(C)(C)C(F)(F)c3ccccc32)cnc1C(F)F]

5-(4,4-Difluoro-3,3-dimethyl-3,4-dihydro-1-isoquinolyl)-2-(difluoromethyl)-3-methylpyridine; and

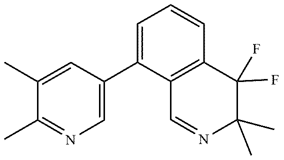 [SMILES: Cc1cc(-c2cccc3c2C=NC(C)(C)C3(F)F)cnc1C]

5-(4,4-Difluoro-3,3-dimethyl-3,4-dihydro-1-isoquinolyl)-2,3-dimethylpyridine.

In a different preferred embodiment of the compound of formula (I), R¹ and R² together form a phenyl ring having one or more halogen substituents at the ring atoms, preferably at least one fluoro substituent, and wherein R³ and R⁴ together form a thiophen ring. A particularly preferred compound (I) is

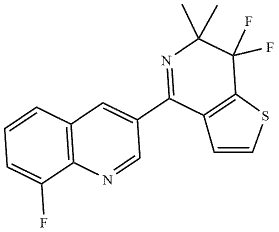 [SMILES: CC1(C)N=C(c2cnc3c(F)cccc3c2)c2ccsc2C1(F)F]

7,7-Difluoro-4-(8-fluoro-3-quinolyl)-6,6-dimethyl-6,7-dihydro-1-thia-5-azaindene.

A skilled person is aware that according to the methods of the invention, the compound or compounds are generally applied as part of a pesticidal composition.

Hence, as embodiment 2, there is provided a method of controlling or preventing infestation of plants by the phytopathogenic microorganism Corynespora cassiicola comprising applying to the phytopathogen, to the locus of the phytopathogen, or to a plant susceptible to attack by the phytopathogen, or to a propagation material thereof, a pesticidal composition comprising a compound as defined herein above, and one or more formulation adjuvants.

As embodiment 3, there is provided the method according to any one of embodiments above comprising the steps of providing a composition comprising a compound as defined in any one of embodiments above; and applying the composition to a propagation material; and planting the propagation material.

As embodiment 4, there is provided the method according to any one of embodiments above comprising the steps of providing a composition comprising a compound as defined herein above; applying the composition to the phytopathogen, to the locus of the phytopathogen, or to a plant susceptible to attack by the phytopathogen.

As embodiment 5, there is provided the use of a compound as defined in any one of previous embodiments for controlling or preventing infestation of plants by the phytopathogenic microorganism Corynespora cassiicola.

As embodiment 6, there is provided a method or use according to any one of embodiments herein above, wherein the plant is selected from beans, cowpea, cucumber, papaya, soybean, sweet potato, tomato, cotton, eggplant, basil, thyme, rubber tree, pawpaw tree, azalea and hydrangea.

As embodiment 7, there is provided a method or use according to any one of embodiments herein above, wherein the plant is selected from beans, cowpea, cucumber, papaya, soybean, sweet potato and tomato.

As embodiment 8, there is provided a method or use according to any one of the previous embodiments, wherein the plant is soybean.

As embodiment 9, the present invention preferably also relates to a pesticidal composition suitable for control of diseases caused by phytopathogens comprising:
(A) a compound of formula I

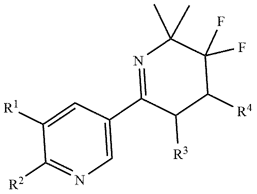

wherein R¹ and R² are each independently selected from a C₁-C₃ alkyl or C₁-C₃ halogenalkyl, or form together an unsubstituted or substituted aryl ring; and R³ and R⁴ form together an unsubstituted or substituted aryl or thiophen ring, and N-oxides and agriculturally acceptable salts thereof; and and as the at least one or more compound(s) (B) other biologically active agents, such as bactericides, fungicides, nematicides, plant activators, acaricides, and insecticides, one or more adjuvant(s), and a diluent or carrier.

Preferred compounds (B) include 2-[6-(4-chlorophenoxy)-2-(trifluoromethyl)-3-pyridyl]-1-(1 ,2,4-triazol-1-yl)propan-2-ol; 2-[6-(4-bromophenoxy)-2-(trifluoromethyl)-3-pyridyl]-1-(1 ,2,4-triazol-1-yl)propan-2-ol (these compound may be prepared from the methods described in WO 2017/029179); 3-[2-(1-chlorocyclopropyl)-3-(2-fluorophenyl)-2-hydroxy-propyl]imidazole-4-carbonitrile; 3-[2-(1-chlorocyclopropyl)-3-(3-chloro-2-fluoro-phenyl)-2-hydroxy-propyl]imidazole-4-carbonitrile (these compound may be prepared from the methods described in WO 2016/156290); (4-Phenoxyphenyl)methyl 2-amino-6-methyl-pyridine-3-carboxylate (this compound may be prepared from the methods described in WO 2014/006945); 2,6-Dimethyl-1H,5H-[1,4]dithiino[2,3-c:5,6-c′]dipyrrole-1,3,5,7(2H,6H)-tetrone (this compound may be prepared from the methods described in WO 2011/138281);

Further preferred compounds (B) include N-methyl-4-[5-(trifluoromethyl)-1,2,4-oxadiazol-3-yl]benzenecarbothioamide; N-methyl-4-[5-(trifluoromethyl)-1,2,4-oxadiazol-3-yl]benzamide. (Z,2E)-5-[1-(2,4-dichlorophenyl)pyrazol-3-yl]oxy-2-methoxyimino-N,3-dimethyl-pent-3-enamide (this compound may be prepared from the methods described in WO 2018/153707); N′-(2-chloro-5-methyl-4-phenoxyphenyl)-N-ethyl-N-methyl-formamidine; N′-[2-chloro-4-(2-fluorophenoxy)-5-methyl-phenyl]-N-ethyl-N-methyl-formamidine (these compounds may be prepared from the methods described in WO 2016/202742); 2-(difluoromethyl)-N-[(3S)-3-ethyl-1,1-dimethyl-indan-4-yl]pyridine-3-carboxamide (this compound may be prepared from the methods described in WO 2014/095675);

2-(4-Bromophenoxy)-2-(trifluoromethyl)-3-pyridyl]-1-(1,2,4-triazol-1-yl)propan-2-ol is disclosed in WO 2017/029179; 4-[[2-(2,4-Difluorophenyl)-1,1-difluoro-2-hydroxy-3-(5-thioxo-4H-1,2,4-triazol-1-yl)propyl]-3-pyridyl]oxy]benzonitrile is disclosed in WO 2016/187201; N′-(2-chloro-5-methyl-4-phenoxy-phenyl)-N-ethyl-N-methyl-formamidine is disclosed in WO 2017/005710; N′-[2-chloro-4-(2-fluorophenoxy)-5-methyl-phenyl]-N-ethyl-N-methyl-formamidine is disclosed in WO 2016/202742;

N-methyl-4-[5-(trifluoromethyl)-1,2,4-oxadiazol-3-yl]benzenecarbothioamide is disclosed inWO 2017/211649; 2,2-difluoro-N-methyl-2-[4-[5-(trifluoromethyl)-1,2,4-oxadiazol-3-yl]phenyl]-acetamide is disclosed in WO 2017/076742; N-(2-fluorophenyl)-4-[5-(trifluoromethyl)-1,2,4-oxadiazol-3-yl]benzamide is disclosed in WO 2015/185485; zhongshengmycin, thiodiazole copper, zinc thiazole, amectotractin, iprodione; fluoxapiprolin, enoxastrobin; trinexapac; coumoxystrobin; coumethoxystrobin; (4-phenoxyphenyl)methyl 2-amino-6-methyl-pyridine-3-carboxylate (aminopyrifen); N-methyl-4-[5-(trifluoromethyl)-1,2,4-oxadiazol-3-yl]benzenecarbothioamide; N-methyl-4-[5-(trifluoromethyl)-1,2,4-oxadiazol-3-yl]benzamide; (Z,2E)-5-[1-(2,4-dichlorophenyl)pyrazol-3-yl]oxy-2-methoxyimino-N,3-dimethyl-pent-3-enamide (Strobilurine); N′-[4-(4,5-dichlorothiazol-2-yl)oxy-2,5-dimethyl-phenyl]-N-ethyl-N-methyl-formamidine; 3-[2-(1-chlorocyclopropyl)-3-(2-fluorophenyl)-2-hydroxy-propyl]imidazole-4-carbonitrile; 3-[2-(1-chlorocyclopropyl)-3-(3-chloro-2-fluoro-phenyl)-2-hydroxy-propyl]imidazole-4-carbonitrile; 2-(difluoromethyl)-N-(3-ethyl-1,1-dimethyl-indan-4-yl)pyridine-3-carboxamide; Methyl (E)-3-methoxy-2-[2-[(5-methoxy-1,3-benzothiazol-2-yl)sulfanylmethyl]phenyl]prop-2-enoate; 4-[[6-[2-(2,4-difluorophenyl)-1,1-difluoro-2-hydroxy-3-(1,2,4-triazol-1-yl)propyl]-3-pyridyl]oxy]benzonitrile;

4-[[2-(2,4-difluorophenyl)-1,1-difluoro-2-hydroxy-3-(5-thioxo-4H-1,2,4-triazol-1-yl)propyl]-3-pyridyl]oxy]benzonitrile; 3-(3,4-dichloro-1,2-thiazol-5-ylmethoxy)-1,2-benzothiazole 1,1-dioxide (Dichlobentiazox); methyl (2E)-2-{2-[({[(2E,3E)-4-(4-chlorophenyl)but-3-en-2-ylidene]-amino}oxy)methyl]phenyl}-3-methoxyprop-2-enoate (Enoxastrobin); 2Z)-2-[2-[[(E)-[(E)-4-(2,6-dichlorophenyl)but-3-en-2-ylidene]amino]oxymethyl]phenyl]-2-methoxyimino-N-methylacetamide (Fenaminstrobin); (3S,6S,7R,8R)-8-benzyl-3-{3-[(isobutyryloxy)methoxy]-4-methoxypyridine-2-carboxamido}-6-methyl-4,9-dioxo-1,5-dioxonan-7-yl isobutyrate (Fenpicoxamid) [(1S)-2,2-bis(4-fluorophenyl)-1-methyl-ethyl] (2S)-2-[(3-acetoxy-4-methoxy-pyridine-2-carbonyl)amino]propanoate (Florylpicoxamid); 3-(difluoromethyl)-N-[(3RS)-7-fluoro-2,3-dihydro-1,1,3-trimethyl-1H-inden-4-yl]-1-methyl-1H-pyrazole-4-carboxamide (Fluindapyr);3-(difluoromethyl)-1-methyl-N-[(3R)-1,1,3-trimethylindan-4-yl]pyrazole-4-carboxamide (Inpyrfluxam); (2RS)-2-[4-(4-chlorophenoxy)-α,α,α-trifluoro-o-tolyl]-3-methyl-1-(1H-1,2,4-triazol-1-yl)butan-2-ol (Ipfentrifluconazole); 2-[2-[(7,8-difluoro-2-methyl-3-quinolyl)oxy]-6-fluoro-phenyl]propan-2-ol (Ipflufenoquin); 2-[2-[(2,5-dimethylphenoxy)methyl]phenyl]-2-methoxy-N-methyl-acetamide (Mandestrobin); (2RS)-2-[4-(4-chlorophenoxy)-α,α,α-trifluoro-o-tolyl]-1-(1H-1,2,4-triazol-1-yl)propan-2-ol (Mefentrifluconazole); 1-[2-[[1-(4-chlorophenyl)pyrazol-3-yl]oxymethyl]-3-methyl-phenyl]-4-methyl-tetrazol-5-one (Metyltetraprole); methyl N-[2-[(2,4-dimethyl-5-phenylpyrazol-3-yl)oxymethyl]phenyl]-N-methoxycarbamate (Pyrametostrobin); methyl (E)-2-[2-[[5-(4-chlorophenyl)-2-methylpyrazol-3-yl]oxymethyl]phenyl]-3-methoxyprop-2-enoate (Pyraoxystrobin); (Z)-N-{2-[3-chloro-5-(cyclopropylethynyl)-2-pyridyl]-2-(isopropoxyimino)ethyl}-3-(difluoromethyl)-1-methylpyrazole-4-carboxamide (Pyrapropoyne); methyl N-methoxy-N-[2-[(3,5,6-trichloropyridin-2-yl)oxymethyl]phenyl]carbamate (Triclopyricarb); N-[2-[2,4-dichloro-phenoxy]phenyl]-3-(difluoromethyl)-1-methyl-pyrazole-4-carboxamide (Lvbenmixianan); N-[2-[2-chloro-4-(trifluoromethyl)phenoxy]¬phenyl]-3-(difluoromethyl)-1-methyl-pyrazole-4-carboxamide (Fubenmixianan);

N-methoxy-N-[[4-[5-(trifluoromethyl)-1,2,4-oxadiazol-3-yl]phenyl]methyl]-cyclopropanecarboxamide, N,2-dimethoxy-N-[[4-[5-(trifluoromethyl)-1,2,4-oxadiazol-3-yl]phenyl]-methyl]propanamide, N-ethyl-2-methyl-N-[[4-[5-(trifluoromethyl)-1,2,4-oxadiazol-3-yl]phenyl]-methyl]propanamide, 1-methoxy-3-methyl-1-[[4-[5-(trifluoromethyl)-1,2,4-oxadiazol-3-yl]phenyl]-methyl]urea, 1,3-dimethoxy-1-[[4-[5-(trifluoromethyl)-1,2,4-oxadiazol-3-yl]phenyl]methyl]urea, 3-ethyl-1-methoxy-1-[[4-[5-(trifluoromethyl)-1,2,4-oxadiazol-3-yl]phenyl]methyl]urea, N-[[4-[5-(trifluoromethyl)-1,2,4-oxadiazol-3-yl]phenyl]-methyl]propanamide, 4,4-dimethyl-2-[[4-[5-(trifluoromethyl)-1,2,4-oxadiazol-3-yl]¬phenyl]methyl]-isoxazolidin-3-one, 5,5-dimethyl-2-[[4-[5-(trifluoromethyl)-1,2,4-oxadiazol-3-yl]phenyl]methyl]-isoxazolidin-3-one, ethyl 1-[[4-[5-(trifluoromethyl)-1,2,4-oxadiazol-3-yl]-phenyl]methyl]pyrazole-4-carboxylate, N,N-dimethyl-1-[[4-[5-(trifluoromethyl)-1,2,4-oxadiazol-3-yl]-phenyl]methyl]-1,2,4-triazol-3-amine. These compounds in this paragraph may be prepared according to the methods described in WO 2017/055473, WO 2017/055469, WO 2017/093348 and WO 2017/118689.

Preferred compounds (B) include 2-[6-(4-bromophenoxy)-2-(trifluoromethyl)-3-pyridyl]-1-(1,2,4-triazol-1-yl)propan-2-ol, 4-[[6-[2-(2,4-difluorophenyl)-1,1-difluoro-2-hydroxy-3-(5-thioxo-4H-1,2,4-triazol-1-yl)propyl]-3-pyridyl]oxy]benzonitrile, N′-(2-chloro-5-methyl-4-phenoxyphenyl)-N-ethyl-N-methyl-formamidine, N′-[2-chloro-4-(2-fluorophenoxy)-5-methyl-phenyl]-N-ethyl-N-methyl-formamidine, N-methyl-4-[5-(trifluoromethyl)-1,2,4-oxadiazol-3-yl]benzenecarbothioamide, 2,2-difluoro-N-methyl-2-[4-[5-(trifluoromethyl)-1,2,4-oxadiazol-3-yl]phenyl]acetamide and N-(2-fluorophenyl)-4-[5-(trifluoromethyl)-1,2,4-oxadiazol-3-yl]benzamide.

Particularly preferred are (4-phenoxyphenyl)methyl 2-amino-6-methyl-pyridine-3-carboxylate (aminopyrifen); 2,6-Dimethyl-1H,5H-[1 ,4]dithiino[2,3-c:5,6-c′]dipyrrole-1 ,3,5,7(2H,6H)-tetrone; N-methyl-4-[5-(trifluoromethyl)-1,2,4-oxadiazol-3-yl]benzenecarbothioamide; N-methyl-4-[5-(trifluoromethyl)-1,2,4-oxadiazol-3-yl]benzamide; (Z,2E)-5-[1-(2,4-dichlorophenyl)pyrazol-3-yl]oxy-2-methoxyimino-N,3-dimethyl-pent-3-enamide; N′-(2-chloro-5-methyl-4-phenoxy-phenyl)-N-ethyl-N-methyl-formamidine; N′-[2-chloro-4-(2-fluorophenoxy)-5-methyl-phenyl]-N-ethyl-N-methyl-formamidine; N′-(2,5-dimethyl-4-phenoxy-phenyl)-N-ethyl-N-methyl-formamidine; N′-[4-(4,5-dichlorothiazol-2-yl)oxy-2,5-dimethyl-phenyl]-N-ethyl-N-methyl-formamidine; 2-[6-(4-bromophenoxy)-2-(trifluoromethyl)-3-pyridyl]-1-(1,2,4-triazol-1-yl)propan-2-ol; 2-[6-(4-chlorophenoxy)-2-(trifluoromethyl)-3-pyridyl]-1-(1,2,4-triazol-1-yl)propan-2-ol; 3-[2-(1-chlorocyclopropyl)-3-(2-fluorophenyl)-2-hydroxy-propyl]imidazole-4-carbonitrile; 3-[2-(1-chlorocyclopropyl)-3-(3-chloro-2-fluoro-phenyl)-2-hydroxy-propyl]imidazole-4-carbonitrile; 2-(difluoromethyl)-N-(3-ethyl-1,1-dimethyl-indan-4-yl)pyridine-3-carboxamide; methyl (E)-3-methoxy-2-[2-[(5-methoxy-1,3-benzothiazol-2-yl)sulfanylmethyl]phenyl]prop-2-enoate; 4-[[6-[2-(2,4-difluorophenyl)-1,1-difluoro-2-hydroxy-3-(1,2,4-triazol-1-yl)propyl]-3-pyridyl]oxy]benzonitrile; 4-[[6-[2-(2,4-difluorophenyl)-1,1-difluoro-2-hydroxy-3-(5-thioxo-4H-1,2,4-triazol-1-yl)propyl]-3-pyridyl]oxy]benzonitrile; 3-(3,4-dichloro-1,2-thiazol-5-ylmethoxy)-1,2-benzothiazole 1,1-dioxide; (3S,6S,7R,8R)-8-benzyl-3-{3-[(isobutyryloxy)methoxy]-4-methoxypyridine-2-carboxamido}-6-methyl-4,9-dioxo-1,5-dioxonan-7-yl isobutyrate; [(1S)-2,2-bis(4-fluorophenyl)-1-methyl-ethyl] (2S)-2-[(3-acetoxy-4-methoxy-pyridine-2-carbonyl)amino]propanoate; 3-(difluoromethyl)-N-(7-fluoro-1,1,3-trimethyl-indan-4-yl)-1-methyl-pyrazole-4-carboxamide; [2-[3-[2-[1-[2-[3,5-bis(difluoromethyl)pyrazol-1-yl]acetyl]-4-piperidyl]thiazol-4-yl]-4,5-dihydroisoxazol-5-yl]-3-chloro-phenyl] methanesulfonate; 3-(difluoromethyl)-1-methyl-N-[(3R)-1,1,3-trimethylindan-4-yl]pyrazole-4-carboxamide; (2RS)-2-[4-(4-chlorophenoxy)-α,α,α-trifluoro-o-tolyl]-3-methyl-1-(1H-1,2,4-triazol-1-yl)butan-2-ol; 2-[2-[(7,8-difluoro-2-methyl-3-quinolyl)oxy]-6-fluoro-phenyl]propan-2-ol; N-[1,1-dimethyl-2-(4-isopropoxy-o-tolyl)-2-oxoethyl]-3-methylthiophene-2-carboxamide; N-[(5-chloro-2-isopropyl-phenyl)methyl]-N-cyclopropyl-3-(difluoromethyl)-5-fluoro-1-methyl-pyrazole-4-carboxamide; 2-[2-[(2,5-dimethylphenoxy)methyl]¬phenyl]¬-2-methoxy-N-methyl-acetamide; (2RS)-2-[4-(4-chlorophenoxy)-α,α,α-trifluoro-o-tolyl]-1-(1H-1 ,2,4-triazol-1-yl)propan-2-ol; 1-[2-[[1-(4-chlorophenyl)pyrazol-3-yl]oxymethyl]-3-methyl-phenyl]-4-methyl-tetrazol-5-one; (Z)-N-{2-[3-chloro-5-(cyclopropylethynyl)-2-pyridyl]-2-(isopropoxyimino)ethyl}-3-(difluoromethyl)-1-methylpyrazole-4-carboxamide; N-[2-(3,4-difluorophenyl)phenyl]-3-(trifluoromethyl)pyrazine-2-carboxamide; 3-chloro-4-(2,6-difluorophenyl)-6-methyl-5-phenyl-pyridazine; 3-(4,4-difluoro-3,4-dihydro-3,3-dimethylisoquinolin-1-yl)quinoline; N-[2-[2,4-dichloro-phenoxy]phenyl]-3-(difluoromethyl)-1-methyl-pyrazole-4-carboxamide; and/or N-[2-[2-chloro-4-(trifluoromethyl)phenoxy]phenyl]-3-(difluoromethyl)-1-methylpyrazole-4-carboxamide.

In each case, the compounds of formula I according to the invention are in free form, in oxidized form as a N-oxide or in salt form, e.g. an agronomically usable salt form. N-oxides are oxidized forms of tertiary amines or oxidized forms of nitrogen containing heteroaromatic compounds. They are described for instance in the book “Heterocyclic N-oxides” by A. Albini and S. Pietra, CRC Press, Boca Raton 1991. The present invention also relates to all stereoisomers and mixtures thereof, in any ratio.

Preferred compositions comprising (A) a compound of formula I are set out as Ia , Ib and/or Ic herein above; and (B) at least one compound selected from the group consisting of 2-[6-(4-bromophenoxy)-2-(trifluoromethyl)-3-pyridyl]-1-(1,2,4-triazol-1-yl)propan-2-ol, N′-[2-chloro-4-(2-fluorophenoxy)-5-methyl-phenyl]-N-ethyl-N-methyl-formamidine, N-methyl-4-[5-(trifluoromethyl)-1,2,4-oxadiazol-3-yl]benzenecarbothioamide and N-(2-fluorophenyl)-4-[5-(trifluoromethyl)-1,2,4-oxadiazol-3-yl]benzamide.

It has been found that the use of component (B) in combination with component (A) surprisingly and substantially enhance the effectiveness of the latter against fungi, and vice versa. Additionally, the method of the invention is effective against a wider spectrum of such fungi that can be combated with the active ingredients of this method, when used solely.

A further aspect of the present invention is a method of controlling diseases on useful plants or on propagation material thereof caused by phytopathogens, which comprises applying to the useful plants, the locus thereof or propagation material thereof a composition according to the invention. Preferred is a method, which comprises applying to the useful plants or to the locus thereof a composition according to the invention, more preferably to the useful plants. Further preferred is a method, which comprises applying to the propagation material of the useful plants a composition according to the invention.

Throughout this document the expression “composition” refers to the various mixtures or combinations of components (A) and (B), for example in a single “ready-mix” form, in a combined spray mixture com¬posed from separate formulations of the single active ingredient components, such as a “tank-mix”, and in a combined use of the single active ingredients when applied in a sequen¬tial manner, i.e. one after the other with a reasonably short period, such as a few hours or days. The order of applying the components (A) and (B) is not essential for working the present invention.

The compositions according to the invention are effective against harmful microorganisms, such as microorganisms, that cause phytopathogenic diseases, in particular against phytopathogenic fungi and bacteria.

Preferably, the formulation comprising a composition according to the invention may comprise of from 0.01 to 90% by weight of the composition comprising compounds (A) and (B), and of from 0 to 20% of an agriculturally acceptable surfactant. Preferably, the formulation further comprises other active agents, in particular microbiocides and pesticides, more generally.

Advantageosuly, the formulation further comprises of from 10 to 99.99% solid or liquid formulation inerts, conservatives and/or adjuvants.

The present invention preferably also relates to a concentrated composition for dilution by the user, comprising a composition according or a formulation according to he invention, comprising of from 2 to 80% by weight, preferably between 5 and 70% by weight, of active agents comprising at least a composition comprising (A) and (B), and optionally, other active agents.

The present invention preferably also relates to a seed dressing formulation for application to plant propagation materials, comprising a composition according to the invention, and further comprising a diluent. Preferably, the seed dressing formulation is in the form of an aqueous suspension or in a dry powder form having good adherence to the plant propagation materials. Preferably, the seed dressing formulation may comprise the active agents in an encapsulated form, prefearbly a slow release capsules and/or microcapsules.

The present invention preferably also relates to a method of combating and controlling phytopathogens, comprising applying a fungicidally effective amount of a composition according to the invention to a pest, a locus of pest, or to a plant susceptible to attack by a pest, with the exception of a method for treatment of the human or animal body by surgery or therapy and diagnostic methods practiced on the human or animal body.

The methods, compositions and uses according to any one of embodiments according to the invention are preferably for controlling or preventing infestation of the crop by the phytopathogenic microorganisms Corynespora cassiicola, that are resistant to other fungicides. Corynespora cassiicola that are “resistant” to a particular fungicide refer e.g. to strains of Corynespora cassiicola fungi that are less sensitive to that fungicide compared to the expected sensitivity of the same species of Corynespora cassiicola fungi. The expected sensitivity can be measured using e.g. a strain that has not previously been exposed to the fungicide. An “effective” amount herein refers to an amount of the active ingredient that shows sufficient biocidal activity, e.g. at least 10%, more preferably at least 20%, yet more preferably at least 50%, and again more preferably at least 70% effectiveness, compared to the blind test. In the present cae, the composition according to the invention preferably comprise at least 0.01 ppm, more preferably at last 0.025 ppm of active ingredient, more preferably at least for example 6 ppm, 3 ppm, 2.2 ppm, 1.5 ppm, 0.8 ppm, 0.74 ppm, 0.25 ppm, 0.2 ppm, or 0.082 ppm as applied.

Application according to the methods or uses according to any one of embodiments according to the invention is preferably to a crop of plants, the locus thereof or propagation material thereof. Preferably application is to the phytopathogen, to the locus of the phytopathogen, or to a plant susceptible to attack by the phytopathogen, or to a propagation material thereof. Application of the compounds as defined in any one of embodiments 1 to 13 can be performed according to any of the usual modes of application, e.g. foliar, drench, soil, in furrow etc.

The compounds as defined in any one of embodiments according to the invention are preferably used for pest control at rates of 1 to 500 g/ha, preferably 50-300 g/ha.

The compounds as defined in any one of embodiments according to the invention are suitable for use on any plant, including those that have been genetically modified to be resistant to active ingredients such as herbicides, or to produce biologically active compounds that control infestation by plant pests.

Generally, a compound as defined in any one of embodiments according to the invention is used in the form of a composition (e.g. formulation) containing a carrier. A compound as defined in any one of embodiments according to the invention and compositions thereof can be used in various forms such as aerosol dispenser, capsule suspension, cold fogging concentrate, dustable powder, emulsifiable concentrate, emulsion oil in water, emulsion water in oil, encapsulated granule, fine granule, flowable concentrate for seed treatment, gas (under pressure), gas generating product, granule, hot fogging concentrate, macrogranule, microgranule, oil dispersible powder, oil miscible flowable concentrate, oil miscible liquid, paste, plant rodlet, powder for dry seed treatment, seed coated with a pesticide, soluble concentrate, soluble powder, solution for seed treatment, suspension concentrate (flowable concentrate), ultra low volume (ulv) liquid, ultra low volume (ulv) suspension, water dispersible granules or tablets, water dispersible powder for slurry treatment, water soluble granules or tablets, water soluble powder for seed treatment and wettable powder.

Compositions of this invention, including all of the above disclosed embodiments and preferred examples thereof, can be mixed with one or more further pesticides including further fungicides, insecticides, nematicides, bactericides, acaricides, growth regulators, chemosterilants, semiochemicals, repellents, attractants, pheromones, feeding stimulants or other biologically active compounds to form a multi-component pesticide giving an even broader spectrum of agricultural protection.

A formulation typically comprises a liquid or solid carrier and optionally one or more customary formulation auxiliaries, which may be solid or liquid auxiliaries, for example unepoxidized or epoxidized vegetable oils (for example epoxidized coconut oil, rapeseed oil or soya oil), antifoams, for example silicone oil, preservatives, clays, inorganic compounds, viscosity regulators, surfactant, binders and/or tackifiers. The composition may also further comprise a fertilizer, a micronutrient donor or other preparations which influence the growth of plants as well as comprising a combination containing the compound of the invention with one or more other biologically active agents, such as bactericides, fungicides, nematicides, plant activators, acaricides, and insecticides.

The compositions are prepared in a manner known per se, in the absence of auxiliaries for example by grinding, screening and/or compressing a solid compound of the present invention and in the presence of at least one auxiliary for example by intimately mixing and/or grinding the compound of the present invention with the auxiliary (auxiliaries). In the case of solid compounds of the invention, the grinding/milling of the compounds is to ensure specific particle size.

Examples of compositions for use in agriculture are emulsifiable concentrates, suspension concentrates, microemulsions, oil dispersibles, directly sprayable or dilutable solutions, spreadable pastes, dilute emulsions, soluble powders, dispersible powders, wettable powders, dusts, granules or encapsulations in polymeric substances, which comprise - at least – a compound of formula (I) as defined herein and the type of composition is to be selected to suit the intended aims and the prevailing circumstances.

As a rule, the compositions comprise 0.1 to 99%, especially 0.1 to 95%, of a compound (A), and optionally compoundd (B), as defined in any one of embodiments according to the invention and 1 to 99.9%, especially 5 to 99.9%, of at least one solid or liquid carrier, it being possible as a rule for 0 to 25%, especially 0.1 to 20%, of the composition to be surfactants (% in each case meaning percent by weight). Whereas concentrated compositions tend to be preferred for commercial goods, the end consumer as a rule uses dilute compositions which have substantially lower concentrations of active ingredient.

With respect to compositions comprising component (A) and component (B); in general, the weight ratio of component (A) to component (B) is from 2000 : 1 to 1 : 1000. The weight ratio of component (A) to component (B) is preferably from 100 : 1 to 1 : 100; more preferably from 20 : 1 to 1 : 50, yet more preferably from 12 : 1 to 1 : 25; yet more preferably from 10 : 1 to 1 : 10, again more preferably from 5 : 1 to 1 : 15; and most preferably from 2 :1 to 1 : 5.

It has been found, surprisingly, that formulations comprising certain weight ratios of component (A) to component (B) are able to give rise to synergistic activity. Therefore, a further aspect of the invention are compositions, wherein component (A) and component (B) are present in the composition in amounts producing a synergistic effect. This synergistic activity is apparent from the fact that the fungicidal activity of the composition comprising component (A) and component (B) is greater than the sum of the fungicidal activities of component (A) and of component (B). This synergistic activity extends the range of action of component (A) and component (B) in two ways. Firstly, the rates of application of component (A) and component (B) are lowered whilst the action remains equally good, meaning that the active ingredient mixture still achieves a high degree of phytopathogen control even where the two individual components have become totally ineffective in such a low application rate range. Secondly, there is a substantial broadening of the spectrum of phytopathogens that can be controlled.

A synergistic effect exists whenever the action of an active ingredient combination is greater than the sum of the actions of the individual components. The action to be expected E for a given active ingredient combination obeys the so-called COLBY formula and can be calculated as follows (COLBY, S.R. “Calculating synergistic and antagonistic responses of herbicide combination”. Weeds, Vol. 15, pages 20-22; 1967):
ppm = milligrams of active ingredient (= a.i.) per liter of spray mixture
X = % action by active ingredient A) using p ppm of active ingredient
Y = % action by active ingredient B) using q ppm of active ingredient.

According to COLBY, the expected (additive) action of active ingredients A)+B) using p+q ppm of active ingredient is

$$\text{E} \text{=} \text{X} \text{+} \text{Y} \text{-} \frac{\text{X} ⋅ \text{Y}}{100}$$

If the action actually observed (O) is greater than the expected action (E), then the action of the combination is super-additive, i.e. there is a synergistic effect. In mathematical terms, synergism corresponds to a positive value for the difference of (O-E). In the case of purely complementary addition of activities (expected activity), said difference (O-E) is zero. A negative value of said difference (O-E) signals a loss of activity compared to the expected activity.

However, besides the actual synergistic action with respect to fungicidal activity, the compositions according to the invention can also have further surprising advantageous properties. Examples of such advantageous properties that may be mentioned are: more advantageuos degradability; improved toxicological and/or ecotoxicological behaviour; or improved characteristics of the useful plants including: emergence, crop yields, more developed root system, tillering increase, increase in plant height, bigger leaf blade, less dead basal leaves, stronger tillers, greener leaf colour, less fertilizers needed, less seeds needed, more productive tillers, earlier flowering, early grain maturity, less plant verse (lodging), increased shoot growth, improved plant vigor, and early germination.

Additional beneficial effects can be the suppression or reduction of development oof resistence against a certain active ingredient, by combinations that may have one or more different modes of action may in particular be beneficial.

Some compositions according to the invention have a systemic action and can be used as foliar, soil and seed treatment fungicides.

With the compositions according to the invention it is possible to inhibit or destroy the phytopathogenic microorganisms which occur in plants or in parts of plants (fruit, blossoms, leaves, stems, tubers, roots) in different useful plants, while at the same time the parts of plants which grow later are also protected from attack by phytopathogenic microorganisms.

The compositions according to the invention can be applied to the phytopathogenic microorganisms, the useful plants, the locus thereof, the propagation material thereof, storage goods or technical materials threatened by microorganism attack.

The compositions according to the invention may be applied before or after infection of the useful plants, the propagation material thereof, storage goods or technical materials by the microorganisms.

The amount of a composition according to the invention to be applied, will depend on various factors, such as the compounds employed; the subject of the treatment, such as, for example plants, soil or seeds; the type of treatment, such as, for example spraying, dusting or seed dressing; the purpose of the treatment, such as, for example prophylactic or therapeutic; the type of fungi to be controlled or the application time.

When applied to the useful plants component (A) is typically applied at a rate of 5 to 2000 g a.i./ha, particularly 10 to 1000 g a.i./ha, e.g. 50, 75, 100 or 200 g a.i./ha, preferably in association with 1 to 5000 g a.i./ha, particularly 2 to 2000 g a.i./ha, e.g. 100, 250, 500, 800, 1000, 1500 g a.i./ha of component (B).

In agricultural practice the application rates of the compositions according to the invention depend on the type of effect desired, and typically range from 20 to 4000 g of total composition per hectare.

When the compositions according to the invention are used for treating seed, rates of 0.001 to 50 g of a compound of component (A) per kg of seed, preferably from 0.01 to 10 g per kg of seed, and preferably 0.001 to 50 g of a compound of component (B), per kg of seed, preferably from 0.01 to 10 g per kg of seed, are generally sufficient.

Examples of foliar formulation types for pre-mix compositions are:
GR: Granules
WP: wettable powders
WG: water dispersable granules (powders)
SG: water soluble granules
SL: soluble concentrates
EC: emulsifiable concentrate
EW: emulsions, oil in water
ME: micro-emulsion
SC: aqueous suspension concentrate
CS: aqueous capsule suspension
OD: oil-based suspension concentrate, and
SE: aqueous suspo-emulsion.

Whereas, examples of seed treatment formulation types for pre-mix compositions are:
WS: wettable powders for seed treatment slurry
LS: solution for seed treatment
ES: emulsions for seed treatment
FS: suspension concentrate for seed treatment
WG: water dispersible granules, and
CS: aqueous capsule suspension.

Examples of formulation types suitable for tank-mix compositions are solutions, dilute emulsions, suspensions, or a mixture thereof, and dusts.

As with the nature of the formulations, the methods of application, such as foliar, drench, spraying, atomizing, dusting, scattering, coating or pouring, are chosen in accordance with the intended objectives and the prevailing circumstances.

The tank-mix compositions are generally prepared by diluting with a solvent (for example, water) the one or more pre-mix compositions containing different pesticides, and optionally further auxiliaries.

Suitable carriers and adjuvants can be solid or liquid and are the substances ordinarily employed in formulation technology, e.g. natural or regenerated mineral substances, solvents, dispersants, wetting agents, tackifiers, thickeners, binders or fertilizers.

Generally, a tank-mix formulation for foliar or soil application comprises 0.1 to 20%, especially 0.1 to 15 %, of the desired ingredients, and 99.9 to 80 %, especially 99.9 to 85 %, of a solid or liquid auxiliaries (including, for example, a diluent or solvent such as water), where the auxiliaries can be a surfactant in an amount of 0 to 20 %, especially 0.1 to 15 %, based on the tank-mix formulation.

Typically, a pre-mix formulation for foliar application comprises 0.1 to 99.9 %, especially 1 to 95 %, of the desired ingredients, and 99.9 to 0.1 %, especially 99 to 5 %, of a solid or liquid adjuvant (including, for example, a solvent such as water), where the auxiliaries can be a surfactant in an amount of 0 to 50 %, especially 0.5 to 40 %, based on the pre-mix formulation.

Normally, a tank-mix formulation for seed treatment application comprises 0.25 to 80%, especially 1 to 75 %, of the desired ingredients, and 99.75 to 20 %, especially 99 to 25 %, of a solid or liquid auxiliaries (including, for example, a solvent such as water), where the auxiliaries can be a surfactant in an amount of 0 to 40 %, especially 0.5 to 30 %, based on the tank-mix formulation.

Typically, a pre-mix formulation for seed treatment application comprises 0.5 to 99.9 %, especially 1 to 95 %, of the desired ingredients, and 99.5 to 0.1 %, especially 99 to 5 %, of a solid or liquid adjuvant (including, for example, a solvent such as water), where the auxiliaries can be a surfactant in an amount of 0 to 50 %, especially 0.5 to 40 %, based on the pre-mix formulation.

Whereas commercial products will preferably be formulated as concentrates (e.g., pre-mix composition (formulation)), the end user will normally employ dilute formulations (e.g., tank mix composition).

Preferred seed treatment pre-mix formulations are aqueous suspension concentrates. The formulation can be applied to the seeds using conventional treating techniques and machines, such as fluidized bed techniques, the roller mill method, rotostatic seed treaters, and drum coaters. Other methods, such as spouted beds may also be useful. The seeds may be presized before coating. After coating, the seeds are typically dried and then transferred to a sizing machine for sizing. Such procedures are known in the art. The compounds of the present invention are particularly suited for use in soil and seed treatment applications. In general, the pre-mix compositions of the invention contain 0.5 to 99.9 especially 1 to 95, advantageously 1 to 50, % by mass of the desired ingredients, and 99.5 to 0.1, especially 99 to 5, % by mass of a solid or liquid adjuvant (including, for example, a solvent such as water), where the auxiliaries (or adjuvant) can be a surfactant in an amount of 0 to 50, especially 0.5 to 40, % by mass based on the mass of the pre-mix formulation.

In addition, further, other biocidally active ingredients or compositions may be combined with the compositions of the invention and used in the methods of the invention and applied simultaneously or sequentially with the compositions of the invention. When applied simultaneously, these further active ingredients may be formulated together with the compositions of the invention or mixed in, for example, the spray tank. These further biocidally active ingredients may be fungicides, herbicides, insecticides, bactericides, acaricides, nematicides and/or plant growth regulators.

In addition, the compositions of the invention may also be applied with one or more systemically acquired resistance inducers (“SAR” inducer). SAR inducers are known and described in, for example, U.S. Pat. No. US6,919,298 and include, for example, salicylates and the commercial SAR inducer acibenzolar-S-methyl.

The compounds as defined in any one of embodiments according to the invention are normally used in the form of compositions and can be applied to the crop area or plant to be treated, simultaneously or in succession with further compounds. These further compounds can be e.g. fertilizers or micronutrient donors or other preparations, which influence the growth of plants. They can also be selective herbicides or non-selective herbicides as well as insecticides, fungicides, bactericides, nematicides, molluscicides or mixtures of several of these preparations, if desired together with further carriers, surfactants or application promoting adjuvants customarily employed in the art of formulation.

The compounds of formula (I) may be used in the form of (fungicidal) compositions for controlling or protecting against the phytopathogen(s) Corynespora cassiicola, comprising as active ingredient at least one compound as defined in any one of embodiments according to the invention, in free form or in agrochemically usable salt form, and at least one of the above-mentioned adjuvants.

The plants and / or target crops in accordance with the invention include conventional as well as genetically enhanced or engineered varieties such as, for example, insect resistant (e.g. Bt. and VIP varieties) as well as disease resistant, herbicide tolerant (e.g. glyphosate- and glufosinate-resistant maize varieties commercially available under the trade names RoundupReady® and LibertyLink®) and nematode tolerant varieties. By way of example, suitable genetically enhanced or engineered crop varieties include the Stoneville 5599BR cotton and Stoneville 4892BR cotton varieties.

The term “plants” and/or “target crops” is to be understood as including also plants that have been rendered tolerant to herbicides like bromoxynil or classes of herbicides (such as, for example, HPPD inhibitors, ALS inhibitors, for example primisulfuron, prosulfuron and trifloxysulfuron, EPSPS (5-enol-pyrovyl-shikimate-3-phosphate-synthase) inhibitors, GS (glutamine synthetase) inhibitors or PPO (protoporphyrinogen-oxidase) inhibitors) as a result of conventional methods of breeding or genetic engineering. An example of a crop that has been rendered tolerant to imidazolinones, e.g. imazamox, by conventional methods of breeding (mutagenesis) is Clearfield® summer rape (Canola). Examples of crops that have been rendered tolerant to herbicides or classes of herbicides by genetic engineering methods include glyphosate- and glufosinate-resistant maize varieties commercially available under the trade names RoundupReady®, Herculex I® and LibertyLink®.

The term “plants” and/or “target crops” is to be understood as including those which naturally are or have been rendered resistant to harmful insects. This includes plants transformed by the use of recombinant DNA techniques, for example, to be capable of synthesising one or more selectively acting toxins, such as are known, for example, from toxin-producing bacteria. Examples of toxins which can be expressed include δ-endotoxins, vegetative insecticidal proteins (Vip), insecticidal proteins of bacteria colonising nematodes, and toxins produced by scorpions, arachnids, wasps and fungi. An example of a crop that has been modified to express the Bacillus thuringiensis toxin is the Bt maize KnockOut® (Syngenta Seeds). An example of a crop comprising more than one gene that codes for insecticidal resistance and thus expresses more than one toxin is VipCot® (Syngenta Seeds). Crops or seed material thereof can also be resistant to multiple types of pests (so-called stacked transgenic events when created by genetic modification). For example, a plant can have the ability to express an insecticidal protein while at the same time being herbicide tolerant, for example Herculex I® (Dow AgroSciences, Pioneer Hi-Bred International).

The term “plants” and/or “target crops” is to be understood as including also plants which have been so transformed by the use of recombinant DNA techniques that they are capable of synthesising antipathogenic substances having a selective action, such as, for example, the so-called “pathogenesis-related proteins” (PRPs, see e.g. EP-A-0 392 225). Examples of such antipathogenic substances and transgenic plants capable of synthesising such antipathogenic substances are known, for example, from EP-A-0 392 225, WO 95/33818, and EP-A-0 353 191. The methods of producing such transgenic plants are generally known to the person skilled in the art and are described, for example, in the publications mentioned above.

Toxins that can be expressed by transgenic plants include, for example, insecticidal proteins from Bacillus cereus or Bacillus popilliae; or insecticidal proteins from Bacillus thuringiensis, such as δ-endotoxins, e.g. Cry1Ab, Cry1Ac, Cry1F, Cry1Fa2, Cry2Ab, Cry3A, Cry3Bb1 or Cry9C, or vegetative insecticidal proteins (Vip), e.g. Vip1, Vip2, Vip3 or Vip3A; or insecticidal proteins of bacteria colonising nematodes, for example Photorhabdus spp., or Xenorhabdus spp., such as Photorhabdus luminescens, Xenorhabdus nematophilus; toxins produced by animals, such as scorpion toxins, arachnid toxins, wasp toxins and other insect-specific neurotoxins; toxins produced by fungi, such as Streptomycetes toxins, plant lectins, such as pea lectins, barley lectins or snowdrop lectins; agglutinins; proteinase inhibitors, such as trypsin inhibitors, serine protease inhibitors, patatin, cystatin, papain inhibitors; ribosome-inactivating proteins (RIP), such as ricin, maize-RIP, abrin, luffin, saporin or bryodin; steroid metabolism enzymes, such as 3-hydroxysteroidoxidase, ecdysteroid-UDP-glycosyl-transferase, cholesterol oxidases, ecdysone inhibitors, HMG-COA-reductase, ion channel blockers, such as blockers of sodium or calcium channels, juvenile hormone esterase, diuretic hormone receptors, stilbene synthase, bibenzyl synthase, chitinases and glucanases.

Further, in the context of the present invention there are to be understood by δ-endotoxins, for example Cry1Ab, Cry1Ac, Cry1F, Cry1Fa2, Cry2Ab, Cry3A, Cry3Bb1 or Cry9C, or vegetative insecticidal proteins (Vip), for example Vip1, Vip2, Vip3 or Vip3A, expressly also hybrid toxins, truncated toxins and modified toxins. Hybrid toxins are produced recombinantly by a new combination of different domains of those proteins (see, for example, WO 02/15701). Truncated toxins, for example a truncated Cry1Ab, are known. In the case of modified toxins, one or more amino acids of the naturally occurring toxin are replaced. In such amino acid replacements, preferably non-naturally present protease recognition sequences are inserted into the toxin, such as, for example, in the case of Cry3A055, a cathepsin-G-recognition sequence is inserted into a Cry3A toxin (see WO03/018810).

More examples of such toxins or transgenic plants capable of synthesising such toxins are disclosed, for example, in EP-A-0 374 753, WO93/07278, WO95/34656, EP-A-0 427 529, EP-A-451 878 and WO03/052073.

The processes for the preparation of such transgenic plants are generally known to the person skilled in the art and are described, for example, in the publications mentioned above. Cryl-type deoxyribonucleic acids and their preparation are known, for example, from WO 95/34656, EP-A-0 367 474, EP-A-0 401 979 and WO 90/13651.

The toxin contained in the transgenic plants imparts to the plants tolerance to harmful insects. Such insects can occur in any taxonomic group of insects, but are especially commonly found in the beetles (Coleoptera), two-winged insects (Diptera) and butterflies (Lepidoptera).

Transgenic plants containing one or more genes that code for an insecticidal resistance and express one or more toxins are known and some of them are commercially available. Examples of such plants are: YieldGard® (maize variety that expresses a Cry1Ab toxin); YieldGard Rootworm® (maize variety that expresses a Cry3Bb1 toxin); YieldGard Plus® (maize variety that expresses a Cry1Ab and a Cry3Bb1 toxin); Starlink® (maize variety that expresses a Cry9C toxin); Herculex I® (maize variety that expresses a Cry1Fa2 toxin and the enzyme phosphinothricine N-acetyltransferase (PAT) to achieve tolerance to the herbicide glufosinate ammonium); NuCOTN 33B® (cotton variety that expresses a Cry1Ac toxin); Bollgard I® (cotton variety that expresses a Cry1Ac toxin); Bollgard II® (cotton variety that expresses a Cry1Ac and a Cry2Ab toxin); VipCot® (cotton variety that expresses a Vip3A and a Cry1Ab toxin); NewLeaf® (potato variety that expresses a Cry3A toxin); NatureGard®, Agrisure® GT Advantage (GA21 glyphosate-tolerant trait), Agrisure® CB Advantage (Bt11 corn borer (CB) trait) and Protecta®.

Further examples of such transgenic crops are:
1. Bt11 Maize from Syngenta Seeds SAS, Chemin de l'Hobit 27, F-31 790 St. Sauveur, France, registration number C/FR/96/05/10. Genetically modified Zea mays which has been rendered resistant to attack by the European corn borer (Ostrinia nubilalis and Sesamia nonagrioides) by transgenic expression of a truncated Cry1Ab toxin. Bt11 maize also transgenically expresses the enzyme PAT to achieve tolerance to the herbicide glufosinate ammonium.
2. Bt176 Maize from Syngenta Seeds SAS, Chemin de l'Hobit 27, F-31 790 St. Sauveur, France, registration number C/FR/96/05/10. Genetically modified Zea mays which has been rendered resistant to attack by the European corn borer (Ostrinia nubilalis and Sesamia nonagrioides) by transgenic expression of a Cry1Ab toxin. Bt176 maize also transgenically expresses the enzyme PAT to achieve tolerance to the herbicide glufosinate ammonium.
3. MIR604 Maize from Syngenta Seeds SAS, Chemin de l'Hobit 27, F-31 790 St. Sauveur, France, registration number C/FR/96/05/10. Maize which has been rendered insect-resistant by transgenic expression of a modified Cry3A toxin. This toxin is Cry3A055 modified by insertion of a cathepsin-G-protease recognition sequence. The preparation of such transgenic maize plants is described in WO 03/018810.
4. MON 863 Maize from Monsanto Europe S.A. 270-272 Avenue de Tervuren, B-1150 Brussels, Belgium, registration number C/DE/02/9. MON 863 expresses a Cry3Bb1 toxin and has resistance to certain Coleoptera insects.
5. IPC 531 Cotton from Monsanto Europe S.A. 270-272 Avenue de Tervuren, B-1150 Brussels, Belgium, registration number C/ES/96/02.
6. 1507 Maize from Pioneer Overseas Corporation, Avenue Tedesco, 7 B-1160 Brussels, Belgium, registration number C/NL/00/10. Genetically modified maize for the expression of the protein Cry1F for achieving resistance to certain Lepidoptera insects and of the PAT protein for achieving tolerance to the herbicide glufosinate ammonium.
7. NK603 × MON 810 Maize from Monsanto Europe S.A. 270-272 Avenue de Tervuren, B-1150 Brussels, Belgium, registration number C/GB/02/M3/03. Consists of conventionally bred hybrid maize varieties by crossing the genetically modified varieties NK603 and MON 810. NK603 × MON 810 Maize transgenically expresses the protein CP4 EPSPS, obtained from Agrobacterium sp. strain CP4, which imparts tolerance to the herbicide Roundup® (contains glyphosate), and also a Cry1Ab toxin obtained from Bacillus thuringiensis subsp. kurstaki which brings about tolerance to certain Lepidoptera, include the European corn borer.

The term “locus” as used herein means fields in or on which plants are growing, or where seeds of cultivated plants are sown, or where seed will be placed into the soil. It includes soil, seeds, and seedlings, as well as established vegetation.

The term “plants” refers to all physical parts of a plant, including seeds, seedlings, saplings, roots, tubers, stems, stalks, foliage, and fruits.

The term “plant propagation material” is understood to denote generative parts of the plant, such as seeds, which can be used for the multiplication of the latter, and vegetative material, such as cuttings or tubers, for example potatoes. There may be mentioned for example seeds (in the strict sense), roots, fruits, tubers, bulbs, rhizomes and parts of plants. Germinated plants and young plants which are to be transplanted after germination or after emergence from the soil, may also be mentioned. These young plants may be protected before transplantation by a total or partial treatment by immersion. Preferably “plant propagation material” is understood to denote seeds.

Pesticidal agents referred to herein using their common name are known, for example, from “The Pesticide Manual”, 15^{th} Ed., British Crop Protection Council 2009.

The compounds as defined in any one of embodiments according to the invention for use in the inventive methods may be the sole active ingredient of a composition or it may be admixed with one or more additional active ingredients such as a pesticide, fungicide, synergist, herbicide or plant growth regulator where appropriate. An additional active ingredient may, in some cases, result in unexpected synergistic activities.

The compositions according to the invention can also comprise further solid or liquid auxiliaries, such as stabilizers, for example unepoxidized or epoxidized vegetable oils (for example epoxidized coconut oil, rapeseed oil or soya oil), antifoams, for example silicone oil, preservatives, viscosity regulators, binders and/or tackifiers, fertilizers or other active ingredients for achieving specific effects, for example bactericides, fungicides, nematocides, plant activators, molluscicides or herbicides.

The compounds, and compositions according to the invention are prepared in a manner known per se, in the absence of auxiliaries for example by grinding, screening and/or compressing a solid active ingredient and in the presence of at least one auxiliary for example by intimately mixing and/or grinding the active ingredient with the auxiliary (auxiliaries). These processes for the preparation of the compositions and the use of the compounds (I) for the preparation of these compositions are also a subject of the invention.

Another aspect of the invention is related to the use of a a compound as defined in any one of embodiments according to the invention, of a composition comprising at least one compound as defined in, or of a fungicidal or insecticidal mixture comprising at least one compound as defined in any one of embodiments according to the invention, in admixture with other fungicides or insecticides as described above, for controlling or preventing infestation of plants, e.g. plants such as crop plants, propagation material thereof, e.g. seeds, harvested crops, e.g. harvested food crops, or non-living material by insects or by phytopathogenic microorganisms, preferably fungal organisms.

A further aspect of invention is related to a method of controlling or preventing an infestation of plants, e.g. plants such as crop plants, propagation material thereof, e.g. seeds, harvested crops, e.g. harvested food crops, or of non-living materials by phytopathogenic or spoilage microorganisms or organisms potentially harmful to man, especially fungal organisms, which comprises the application of a compound as defined in any one of embodiments according to the invention as active ingredient to the plants, to parts of the plants or to the locus thereof, to the propagation material thereof, or to any part of the non-living materials.

Controlling or preventing means reducing infestation by insects or by phytopathogenic or spoilage microorganisms or organisms potentially harmful to man, especially fungal organisms, to such a level that an improvement is demonstrated.

A preferred method of controlling or preventing an infestation of crop plants by phytopathogenic microorganisms, especially fungal organisms, or insects which comprises the application of a a compound as defined in any one of embodiments according to the invention, or an agrochemical composition which contains at least one of said compounds, is foliar application. The frequency of application and the rate of application will depend on the risk of infestation by the corresponding pathogen or insect.

However, the compounds of formula (I), preferably in association with a compound (B), can also penetrate the plant through the roots via the soil (systemic action) by drenching the locus of the plant with a liquid formulation, or by applying the compounds in solid form to the soil, e.g. in granular form (soil application). In crops of water rice such granulates can be applied to the flooded rice field. The compounds of formula (I) may also be applied to seeds (coating) by impregnating the seeds or tubers either with a liquid formulation of the fungicide or coating them with a solid formulation.

Further characteristics of preferred binary compositions comprising compounds of formula (I), their application methods to cereals and their use rates are as described for compositions comprising compounds of formula (I) and additionally preferably at least one component (B) as described above.

Their application can be both before and after the infection of the plants or parts thereof with the fungi. The treatment is preferably carried out prior to the infection. When a compound of formula (I) is used on its own, the application rates in the method accoding to the invention are as described above, e.g. typical are rates of 5 to 2000 g a.i./ha, particularly 10 to 1000 g a.i./ha, e.g. 50, 75, 100 or 200 g a.i./ha. Compounds of formula (I) can be applied to the plants once or more than once during a growing season.

For use in the method according to the invention, the compounds of formula (I) can be converted into the customary formulations described above, e.g. solutions, emulsions, suspensions, dusts, powders, pastes and granules. The use form will depend on the particular intended purpose; in each case, it should ensure a fine and even distribution of the compound of formula (I).

The term “plant” as used herein includes seedlings, bushes and crops of fruits and vegetables.

The Examples which follow serve to illustrate the invention, “active ingredient” denotes a mixture of component (A) and component (B) in a specific mixing ratio. The same formulations can be used for compositions comprising only a compound of formula (I) as the active ingredient.

The invention will now be illustrated by the following non-limiting Examples. All citations are incorporated by reference.

Formulation Examples

| Wettable powders | a) | b) |
|---|---|---|
| active ingredient [A): B) = 1:3(a), 1:1 (b)] | 25 % | 75 % |
| sodium lignosulfonate | 5 % | - |
| sodium lauryl sulfate | 3 % | 5 % |
| sodium diisobutylnaphthalenesulfonate (7-8 mol of ethylene oxide) | - | 10 % |
| highly dispersed silicic acid | 5 % | 10 % |
| kaolin | 62 % | - |

The active ingredient is thoroughly mixed with the other formulation components and the mixture is thoroughly ground in a suitable mill, affording wettable powders that can be diluted with water to give suspensions of the desired concentration.

| Powders for dry seed treatment | a) | b) |
|---|---|---|
| active ingredient [A) : B) = 1:3(a), 1:1 (b)] | 25 % | 75 % |
| light mineral oil | 5 % | 5 % |
| highly dispersed silicic acid | 5 % | - |
| kaolin | 65 % | - |
| talc | - | 20 |

The active ingredient is thoroughly mixed with the other formulation components and the mixture is thoroughly ground in a suitable mill, affording powders that can be used directly for seed treatment.

| Emulsifiable concentrate | |
|---|---|
| active ingredient (A): B) = 1:6) | 10 % |
| octylphenol polyethylene glycol ether (4-5 mol of ethylene oxide) | 3 % |
| calcium dodecylbenzenesulfonate | 3 % |
| castor oil polyglycol ether (35 mol of ethylene oxide) | 4 % |
| cyclohexanone | 30 % |
| xylene mixture | 50 % |

Emulsions of any required dilution, which can be used in plant protection, can be obtained from this concentrate by dilution with water.

| Dustable powders | a) | b) |
|---|---|---|
| active ingredient [A) : B) = 1:6(a), 1:10(b)] | 5% | 6% |
| Talcum | 95 % | - |
| kaolin | - | 94 % |

Ready-for-use dusts are obtained by mixing the active ingredient with the carriers and grinding the mixture in a suitable mill. Such powders can also be used for dry dressings for seed.

| Extruded granules | % w/w |
|---|---|
| active ingredient (A) : B) = 2:1) | 15 % |
| sodium lignosulfonate | 2% |
| sodium alkyl naphthalene sulfonate | 1 % |
| Kaolin | 82 % |

The active ingredient is mixed and ground with the other formulation components, and the mixture is moistened with water. The mixture is extruded and then dried in a stream of air.

| Suspension concentrate | |
|---|---|
| active ingredient (A) : B) = 1:8) | 40 % |
| propylene glycol | 10 % |
| nonylphenol polyethylene glycol ether (15 mol of ethylene oxide) | 6 % |
| sodium lignosulfonate | 10 % |
| carboxymethylcellulose | 1 % |
| silicone oil (in the form of a 75 % emulsion in water) | 1 % |
| water | 32 % |

The finely ground active ingredient is intimately mixed with the other formulation components, giving a suspension concentrate which can be diluted in water at any desired rate. Using such dilutions, living plants as well as plant propagation material can be treated and protected against infestation by microorganisms, by spraying, pouring or immersion.

| Flowable concentrate for seed treatment | |
|---|---|
| active ingredient (A) : B) = 1:8) | 40 % |
| propylene glycol | 5 % |
| copolymer butanol PO/EO | 2 % |
| tristyrenephenole ethoxylate (with 10-20 moles EO) | 2 % |
| 1,2-benzisothiazolin-3-one | 0.5 % |
| monoazo-pigment calcium salt | 5 % |
| silicone oil (in the form of a 75 % emulsion in water) | 0.2 % |
| Water | 45.3 % |

The finely ground active ingredient is intimately mixed with the other formulation components, giving a suspension concentrate which can be diluted further in water to be applied to seeds. Using such dilutions, propagation material can be treated and protected against infestation by microorganisms, by spraying, pouring or immersion.

### Biological Examples

### Example 1: Corynespora Cassiicola (Target Leaf Spot)

Conidia of the fungus from cryogenic storage were directly mixed into nutrient broth (PDB potato dextrose broth). A DMSO solution of the test compounds was placed into a microtiter plate (96-well format) and the nutrient broth containing the fungal spores was added to it. The test plates were incubated at 24° C. and the inhibition of growth (% control of Corynespora cassiicola) was determined photometrically after 3-4 days at 620 nm. The activity of a compound is derived by comparing the inhibition of growth in the treated test solution to the growth in the untreated check. The concentration of the compounds was 6.7, 2.2, 0.74, 0.25, and 0.082 ppm.

Compound (la) gave at least 70% control of Corynespora cassiicola at 6.7 ppm, at least 70% control at 2.2 ppm, at least 50% control at 0.74 ppm, and at least 20% at both 0.25 ppm when compared to untreated control under the same conditions, which showed extensive disease development.

Compound (lb) gave at least 90 % control of Corynespora cassiicola at 6.7 ppm, at least 70% control at 2.2 ppm, at least 50% control at 0.74 ppm, and at least 20% at both 0.25 ppm when compared to untreated control under the same conditions, which showed extensive disease development.

Compound (Ic) gave at least 70% control of Corynespora cassiicola at 6.7 ppm, at least 70% control at 2.2 ppm, at least 50% control at 0.74 ppm, and at least 20% at both 0.25 ppm when compared to untreated control under the same conditions, which showed extensive disease development.

Accordingly, the compounds of formula (I) may for example be distinguished from other compounds by virtue of greater efficacy at low application rates, which can be verified by the person skilled in the art using the experimental procedures outlined in the above biological test, using lower application rates if necessary, for example 6 ppm, 3 ppm, 2.2 ppm, 1.5 ppm, 0.8 ppm, 0.74 ppm, 0.25 ppm, 0.2 ppm, or 0.082 ppm.

1. A method of controlling or preventing infestation of plants by the phytopathogenic microorganism Corynespora cassiicola, comprising applying to the phytopathogen, to the locus of the phytopathogen, or to a plant susceptible to attack by the phytopathogen, or to a propagation material thereof, a fungicidally effective amount of a compound according to formula I: 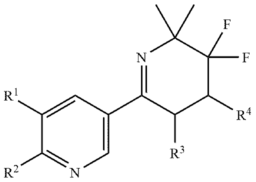
wherein:
R¹ and R² are each independently selected from a C₁-C₃ alkyl or C₁-C₃ alkyl halogenalkyl, or form together an unsubstituted or substituted aryl ring; and
R³ and R⁴ form together an unsubstituted or substituted aryl or tiophen ring, or N-oxides and or agriculturally acceptable salt thereof.

2. The method according to claim 1, wherein R¹ and R² are each independently methyl, or R¹ represents methyl and R² represents —CHF₂.

3. The method according to claim 1, wherein R¹ and R² together form a phenyl ring having one or more halogen substituents at the ring atoms, preferably at least one fluoro substituent, and wherein R³ and R⁴ together form a tiophen ring.

4. The method according to claim 1, wherein the compound according to formula (1) is selected from 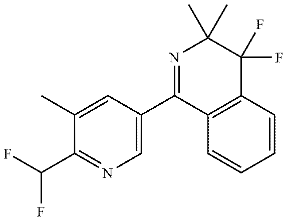 [SMILES: Cc1cc(C2=NC(C)(C)C(F)(F)c3ccccc32)cnc1C(F)F]
5-(4,4-Difluoro-3,3-dimethyl-3,4-dihydro-1-isoquinolyl)-2-(difluoromethyl)-3-methylpyridine; 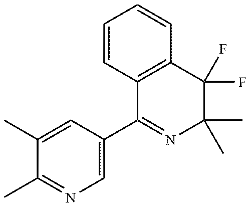
5-(4,4-Difluoro-3,3-dimethyl-3,4-dihydro-1-isoquinolyl)-2,3-dimethylpyridine; and 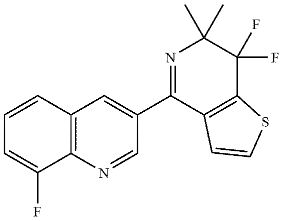 [SMILES: CC1(C)N=C(c2cnc3c(F)cccc3c2)c2ccsc2C1(F)F]
7,7-Difluoro-4-(8-fluoro-3-quinolyl)-6,6-dimethyl-6,7-dihydro-1-thia-5-azaindene.

5. The method according to claim 1, comprising the steps of providing a composition comprising a compound of formula (I) in a biocidally effective amount; and applying the composition to a propagation material; and planting the propagation material.

6. The method according to claim 1, comprising the steps of providing a composition comprising a compound of formula (I) in a biocidally effective amount; and applying the composition to the phytopathogen, to the locus of the phytopathogen, or to a plant susceptible to attack by the phytopathogen.

7. The method according to claim 1 wherein the plant is selected from beans, cowpea, cucumber, papaya, soybean, sweet potato, tomato, cotton, eggplant, basil, thyme, rubber tree, pawpaw tree, azalea and hydrangea.

8. The method according to claim 7, wherein the plant is selected from beans, cowpea, cucumber, papaya, soybean, sweet potato and tomato.

9. The method or use according to claim 8 wherein the plant is soybean.

10. An agricultural chemical formulation for use in controlling or preventing infestation of plants by the phytopathogenic microorganisms Cory nespora cassiicola, comprising applying to the phytopathogen, to the locus of the phytopathogen, or to a plant susceptible to attack by the phytopathogen, or to a propagation material thereof, comprising a fungicidally effective amount of a compound (A) according to formula (I) 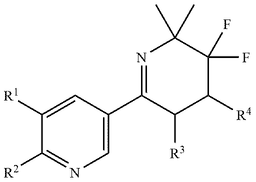
wherein:
R¹ and R² are each independently selected from a C₁-C₃ alkyl or C₁-C₃ alkyl halogenalkyl, or form together an unsubstituted or substituted and ring; and
R³ and R⁴ form together an unsubstituted or substituted aryl or tiophen ring, or N-oxides and or agriculturally acceptable salt thereof, in a biocidally effective amount, N-oxide or agriculturally acceptable salts thereof as a first active ingredient, and as the at least one or more compound(s) (B) other biologically active agents, such as bactericides, fungicides, nematicides, plant activators, acaricides, and insecticides, one or more adjuvant(s), and a diluent or carrier.

11. A composition according to claim 10, comprising:
(A) at least one compound of formula I, 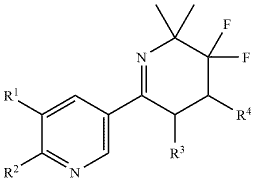
wherein:
R¹ and R² are each independently selected from a C₁-C₃ alkyl or C₁-C₃ alkyl halogenalkyl, or form together an unsubstituted or substituted aryl ring; and
R³ and R⁴ form together an unsubstituted or substituted aryl or tiophen ring, or N-oxides and or agriculturally acceptable salt thereof, in a biocidally effective amount, N-oxide or agriculturally acceptable salts thereof as a first active ingredient, an agrochemically acceptable salt or N-oxide thereof as a first active ingredient; and
(B) at least a second active ingredient selected from the group consisting of 2-[6-(4-bromophenoxy)-2-(trifluoromethyl)-3-pyridyl]-1-(1,2,4-triazol-1-yl)propan-2-ol, 4-[[6-[2-(2,4-difluorophenyl)-1,1-difluoro-2-hydroxy-3-(5-thioxo-4H-1,2,4-triazol-1-yl)propyl]-3-pyridyl]oxy]benzonitrile, N′-(2-chloro-5-methyl-4-phenoxy-phenyl)-N-ethyl-N-methyl-formamidine, N′-[2-chloro-4-(2-fluorophenoxy)-5-methyl-phenyl]-N-ethyl-N-methyl-formamidine, N-methyl-4-[5-(trifluoromethyl)-1,2,4-oxadiazol-3-yl]benzenecarbothioamide, 2,2-difluoro-N-methyl-2-[4-[5-(trifluoromethyl)-1,2,4-oxadiazol-3-yl]phenyl]acetamide and N-(2-fluorophenyl)-4-[5-(trifluoromethyl)-1,2,4-oxadiazol-3-yl]benzamide, or combinations thereof.

12. A formulation comprising a composition according to claim 10 , comprising of from 0.01 to 90% by weight of the composition comprising compounds (A) and (B), and of from 0 to 20% of an agriculturally acceptable surfactant.

13. A concentrated composition for dilution by the user, comprising a composition according to claim 10, comprising of from 2 to 80% by weight, preferably between 5 and 70% by weight, of active agents comprising at least a composition comprising (A), and preferably and (B), and optionally, other active agents.

14. A seed dressing formulation for application to plant propagation materials, comprising a composition according to claim 10, and further comprising a diluent.

15. A seed dressing formulation according to claim 14, wherein the formulation is in an aqueous suspension or in a dry powder form having good adherence to the plant propagation materials.

16. A seed dressing formulation according to claim 14 comprising the active agents in an encapsulated form, prefearbly a slow release capsules and/or microcapsules.

17. The use of a fungicidally effective amount of a compound of formula (I), N-oxide or the agriculturally acceptable salts thereof, of a composition comprising a fungicidally effective amount of a compound of formula (I), N-oxide or the agriculturally acceptable salts thereof as active ingredient component (A); and, optionally, as component (B) at least one compound selected from the group consisting of 2-[6-(4-bromophenoxy)-2-(trifluoromethyl)-3-pyridyl]-1-(1,2,4-triazol-1-yl)propan-2-ol, 4-[[6-[2-(2,4-difluorophenyl)-1,1-difluoro-2-hydroxy-3-(5-thioxo-4H-1,2,4-triazol-1-yl)propyl]-3-pyridyl]oxy]benzonitrile, N′-(2-chloro-5-methyl-4-phenoxy-phenyl)-N-ethyl-N-methyl-formamidine, N′-[2-chloro-4-(2-fluorophenoxy)-5-methylphenyl]-N-ethyl-N-methyl-formamidine, N-methyl-4-[5-(trifluoromethyl)-1,2,4-oxadiazol-3-yl]benzenecarbothioamide, 2,2-difluoro-N-methyl-2-[4-[5-(trifluoromethyl)-1,2,4-oxadiazol-3-yl]phenyl]acetamide and N-(2-fluorophenyl)-4-[5-(trifluoromethyl)-1,2,4-oxadiazol-3-yl]benzamide, or combinations thereof.for controlling or preventing infestation of plants by the phytopathogenic microorganism Corynespora cassiicola.
